(19) United States
(12) Patent Application Publication
(10) Pub. No.: US 2016/0056594 A1
(43) Pub. Date: Feb. 25, 2016

(54) High Definition Multimedia Interface HDMI Plug

(71) Applicant: Huawei Device Co., Ltd., Shenzhen (CN)

(72) Inventors: Bai Sun, Shenzhen (CN); Zhiyong Tang, Wuhan (CN); Xiaoqing Qin, Shenzhen (CN)

(21) Appl. No.: 14/933,103

(22) Filed: Nov. 5, 2015

Related U.S. Application Data
(63) Continuation of application No. PCT/CN2014/077105, filed on May 9, 2014.

(30) Foreign Application Priority Data
May 9, 2013 (CN) 201320248664.0

(51) Int. Cl. H01R 24/60

(52) U.S. Cl. CPC H01R 24/60; H01R 2107/00

(57) ABSTRACT

A high definition multimedia interface (HDMI) plug is provided that relates to connector technologies, which achieves a purpose of a concise appearance and convenience in use while resolving the problem of plug interference. The plug in the present invention includes a plug body and an HDMI interface connecting to an external socket, where the HDMI interface plug further includes an insulation housing disposed between the plug body and the HDMI interface, where one end of the HDMI interface is disposed inside the insulation housing and the other end is disposed outside the insulation housing, and the insulation housing and the plug body are connected in a rotatable manner. Embodiments are used for connection to an audiovisual device.

### CROSS-REFERENCE TO RELATED APPLICATIONS

This application is a continuation of International Application No. PCT/CN2014/077105, filed on May 9, 2014, which claims priority to Chinese Patent Application No. 201320248664.0, filed on May 9, 2013, both of which are incorporated herein by reference in their entireties.

### TECHNICAL FIELD

The present disclosure relates to connectors, and in particular, to a high definition multimedia interface (HDMI) plug.

### BACKGROUND

An HDMI interface is a digital video/audio interface, a dedicated digital interface suitable for image transmission. It can transmit audio and video signals at the same time, and is widely applied to digital versatile disc (DVD) players, set top boxes (a video converter) for cable television/satellite television, high definition television (HDTV) and other digital audiovisual devices. The HDMI interface becomes an indispensable important component in the audiovisual industry because it can effectively enhance digital image quality and does not need analog-to-digital conversion.

An existing HDMI interface plug is similar to a universal serial bus (USB) flash drive, and its body is mostly a plastic case structure of integrated overmolding. When the HDMI interface plug is plugged in a socket of an audiovisual device, the plastic case tends to interfere with a boss on the audiovisual device, or when there are many closely placed interface sockets on the audiovisual device, interference also tends to occur between a plug and a tap or between a plug and another part. A proposed solution to resolve the problem is to add a cable with an HDMI interface to implement connection between the HDMI plug and the audiovisual device. This obviously results in ugly appearance, and on the other hand causes inconvenience in use.

Therefore, an HDMI interface plug needs to be provided to achieve a purpose of a concise appearance and convenience in use while resolving the problem of plug interference.

### SUMMARY

Embodiments of the present disclosure provide an HDMI plug, so as to achieve a purpose of a concise appearance in use and convenient use while resolving a problem of plug interference.

To achieve the foregoing purpose, the following technical solution is used in the embodiments of the present disclosure.

A first aspect provides an HDMI plug, where the plug includes a plug body and an HDMI interface connecting to an external socket, and further includes an insulation housing disposed between the plug body and the HDMI interface, where one end of the HDMI interface is disposed inside the insulation housing and the other end is disposed outside the insulation housing, and the insulation housing and the plug body are connected in a rotatable manner.

In a first possible implementation manner, two opposite side walls are extended from the front end of the plug body and the insulation housing is disposed between the side walls, where a mounting hole is provided in the side walls, and a rotating part is permanently connected to the insulation housing, where the rotating part is disposed in the mounting hole.

With reference to the first possible implementation manner, in a second possible implementation manner, the rotating part includes a housing permanently connected to the insulation housing and a rotating shaft axially moving relative to the housing, where one end of the rotating shaft is disposed inside the housing and connected to the bottom of the housing using a spring, and the other end is disposed inside the mounting hole.

With reference to the second possible implementation manner, in a third possible implementation manner, multiple elastic protrusions are provided on a circumference of the rotating shaft, and grooves cooperating with the elastic protrusions are provided on the inner wall of the mounting hole.

In a fourth possible implementation manner, the plug body includes a case and a mainboard disposed inside the case. The HDMI interface is connected to the mainboard using a coaxial cable. A first cable access hole is provided on the bottom side wall of the insulation housing, and a second cable access hole is provided on the side wall of the case.

With reference to the first possible implementation manner, in a fifth possible implementation manner, the mounting hole is provided on one side wall of the insulation housing, and the first cable access hole is provided on the other opposite side wall.

In a sixth possible implementation manner, the insulation housing includes an upper cover and a lower cover that are fastened to each other, where the upper cover and the lower cover are connected using a countersunk screw.

With reference to the sixth possible implementation manner, in a seventh possible implementation manner, a pad is further disposed between the countersunk screw and the insulation housing.

According to the HDMI plug provided in the embodiments of the present disclosure, because an HDMI interface is connected to a plug body in a rotatable manner using an insulation housing, when interference occurs between plug bodies of adjacent plugs or between the plug body and another part, the plug body may be rotated by a specific angle relative to the interface to dodge an adjacent part. The HDMI plug in the present disclosure does not need help from another cable in use, and is therefore concise in appearance and convenient to use.

### BRIEF DESCRIPTION OF DRAWINGS

To describe the technical solutions in the embodiments of the present disclosure more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic diagram of a state of an HDMI plug according to the present disclosure;

FIG. 2 is a schematic diagram of another state of an HDMI plug according to the present disclosure; and

FIG. 3 is a schematic structural diagram of an insulation housing shown in FIG. 2.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

It should be noted that the “high definition multimedia interface (HDMI)” in the following is called “HDMI interface” for short unless otherwise stated.

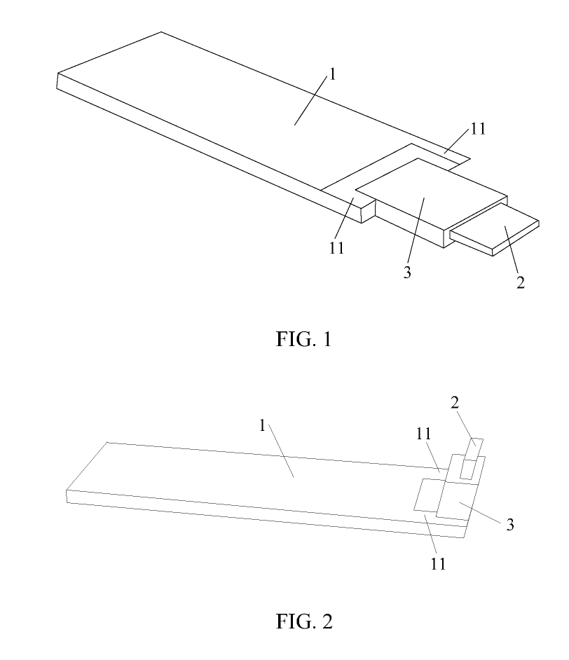

As shown in FIG. 1 and FIG. 2, the embodiments of the present disclosure provide an HDMI plug. The plug includes a plug body 1 and an HDMI interface 2 connecting to an external socket, where the plug further includes an insulation housing 3 disposed between the plug body 1 and the HDMI interface 2, where one end of the HDMI interface 2 is disposed inside the insulation housing 3 and the other end is disposed outside the insulation housing 3, and the insulation housing 3 and the plug body 1 are connected in a rotatable manner.

According to the HDMI plug provided in the embodiments of the present disclosure, because an HDMI interface is connected to a plug body in a rotatable manner using an insulation housing, when interference occurs between plug bodies of adjacent plugs or between the plug body and another part, the plug body may be rotated by a specific angle relative to the interface to dodge an adjacent part. The HDMI interface plug in the present disclosure does not need help from another cable in use, and is therefore concise in appearance and convenient to use.

With respect to the foregoing embodiment, it should be noted that a wireless signal receiving apparatus (such as WiFi) may be disposed inside the plug body, or a flexible cable may be led out of the plug body to receive a video/audio signal. The signal is processed using the HDMI interface and then transmitted to an audiovisual device for listening by a user. In addition, it may be understood that, because a size of the HDMI interface is much smaller than that of the plug body, an HDMI interface with an insulation housing on the exterior is still smaller than the size of the plug body, thereby resolving the interference problem to some extent.

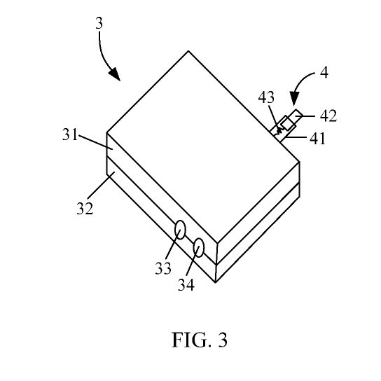

In the foregoing embodiment in which the insulation housing and the plug body are connected in a rotatable manner, there are multiple connection manners, for example, gear meshing connection or chain convey or belt convey. In the present disclosure, the following connection manner is selected exemplarily. As shown in FIG. 1 to FIG. 3, two opposite side walls 11 are extended from the front end of the plug body 1; the insulation housing 3 is disposed between the two opposite side walls 11; a mounting hole (not shown in the figures) is provided on the side walls 11; a rotating part 4 is permanently connected to the insulation housing 3; and the rotating part 4 is disposed in the mounting hole. In this way, relative rotation between the insulation housing 3 and the plug body 1 is implemented by means of rotation of the rotating part 4 in the mounting hole. It may be understood that, with the two opposite side walls 11 extended from the front end of the plug body 1 and the insulation housing 3 disposed between the two side walls 11, the rotating part 4 is also restricted between the two side walls 11 and the insulation housing 3, making the plug look better. In this embodiment, as shown in FIG. 3, one rotating part may be disposed on one side of the insulation housing, or two rotating parts may be disposed on both sides of the insulation housing. When rotating parts are disposed on both sides of the insulation housing, the rotating parts are preferably disposed in symmetry. In addition, the mounting hole is preferably a non-through hole so that the rotating part cannot be seen from the outside of the plug, making the plug look better. Furthermore, integrated injection molding is preferred for the plug body and the side wall extended from the front end of the plug body, which simplifies the manufacturing technique on one hand and makes the plug structure more consistent on the other hand.

As shown in FIG. 3, as a preferred solution of the foregoing embodiment, the rotating part 4 includes a housing 41 permanently connected to the insulation housing 3 and a rotating shaft 42 axially moving relative to the housing, where one end of the rotating shaft 42 is disposed inside the housing 41 and connected to the bottom of the housing 41 using a spring 43, and the other end is disposed inside the mounting hole. In this way, the rotating part forms a stretchable structure. When the plug is assembled, the rotating shaft 42 moves into the housing 41 under the squeeze pressure force of the side walls 11, and the spring 43 is pressed. When the rotating shaft 42 arrives at the position of the mounting hole, the rotating shaft 42 extends out of the housing 41 under the resilience force of the spring 43 and enters the mounting hole. On one hand, this facilitates the convenience of plug assembling, and on the other hand, a smaller gap between the insulation housing and the side walls is ensured after the assembling, making the plug structure more compact and the plug look better. It should be noted that the connection between the rotating shaft and the housing is of synchronous rotation in a rotation direction and of relative movement in an axial direction, and therefore a connection structure of the rotating shaft may be spline connection.

To enable the HDMI interface to stably stay on different positions, multiple elastic protrusions (not shown in the figure) are provided on a circumference of the rotating shaft; and grooves (not shown in the figure) cooperating with the elastic protrusions are provided on the inner wall of the mounting hole. In this way, when rotating to a position in which the elastic protrusions correspond to the grooves on the inner wall of the mounting hole, the rotating shaft may stay at the position. When the rotating shaft is required to continue the rotation, an external force by which the elastic protrusions are so pressed that they go out of the grooves must be depended on. That is, the rotation of the rotating shaft inside the mounting hole is a wedge moving process, and therefore the number of elastic protrusions may be determined according to an actual requirement such that the rotating shaft may be wedged in different positions, for example, a 45-degree or 90-degree angle position. However, in actual processing, in order to simplify the technique, the rotating shaft uses an elastic material (such as plastic), and its cross section is processed into a polygon in which edges between sides are the elastic protrusions. The mounting hole is also processed into a polygon matching the rotating shaft, where edges on the inner wall of the mounting hole are the grooves.

Generally, the plug body includes a case and a mainboard disposed inside the case, and the HDMI interface is connected to the mainboard using a coaxial cable. Therefore, a first cable access hole 34 is provided on the side wall of the insulation housing, and a second cable access hole is provided on the side wall of the case. In this way, the coaxial cable implements the connection between the HDMI interface and the mainboard using the first cable access hole and the second cable access hole.

To prevent the cable from interfering with the rotating part, in this embodiment of the present disclosure, the rotating part is preferably disposed on one side wall (side wall on the right) of the insulation housing, and the first cable access hole 34 is provided on the other opposite side wall (side wall on the left).

To facilitate plug assembling, the insulation housing 3 includes an upper cover 31 and a lower cover 32 that are fastened to each other, where the upper cover 31 and the lower cover 32 are connected using a countersunk bolt. Specifically, a countersunk hole 33 for housing the countersunk bolt is provided on side walls of the upper cover 31 and the lower cover 32, and the connection between the upper cover 31 and the lower cover 32 is implemented by providing the countersunk bolt penetrated through the countersunk hole. This facilitates plug assembling, and further facilitates later plug disassembling and maintenance. The countersunk bolt is completely hidden inside the insulation housing, preventing the bolt from interfering with the plug body on one hand, and making the plug appearance more concise on the other hand. The present disclosure is not limited thereto, and the upper cover and the lower cover may also be connected using a fastener, which makes assembling simple and convenient.

Further, a pad is further disposed between the countersunk bolt and the insulation housing. In this way, the connection between the two is securer and a loose bolt caused by frequent rotation is prevented.

The foregoing descriptions are merely embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A high definition multimedia interface (HDMI) plug, comprising:
a plug body;
an HDMI interface connecting to an external socket; and
an insulation housing disposed between the plug body and the HDMI interface,
wherein a first end of the HDMI interface is disposed inside the insulation housing and a second end is disposed outside the insulation housing, and
wherein the insulation housing and the plug body are connected in a rotatable manner.

2. The plug according to claim 1, wherein two opposite side walls are extended from a front end of the plug body, wherein the insulation housing is disposed between the two opposite side walls, wherein a mounting hole is provided in the two opposite side walls, wherein a rotating part is permanently connected to the insulation housing, and wherein the rotating part is disposed in the mounting hole.

3. The plug according to claim 2, wherein the rotating part comprises:
a housing permanently connected to the insulation housing; and
a rotating shaft axially moving relative to the housing,
wherein a first end of the rotating shaft is disposed inside the housing and connected to a bottom of the housing using a spring, and
wherein a second end of the rotating shaft is disposed inside the mounting hole.

4. The plug according to claim 3, wherein multiple elastic protrusions are provided on a circumference of the rotating shaft, and wherein grooves cooperating with the elastic protrusions are provided on an inner wall of the mounting hole.

5. The plug according to claim 4, wherein the plug body comprises a case and a mainboard disposed inside the case, wherein the HDMI interface is connected to the mainboard using a coaxial cable, wherein a first cable access hole is provided on a bottom side wall of the insulation housing and wherein a second cable access hole is provided on a side wall of the case.

6. The plug according to claim 5, wherein the mounting hole is provided on a first side wall of the insulation housing, and wherein the first cable access hole is provided on a second side wall opposite the first side wall.

7. The plug according to claim 1, wherein the insulation housing comprises an upper cover and a lower cover that are fastened to each other, and wherein the upper cover and the lower cover are connected using a countersunk screw.

8. The plug according to claim 7, further comprising a pad disposed between the countersunk screw and the insulation housing.
